(19) United States
(12) Patent Application Publication
(10) Pub. No.: US 2004/0259068 A1
(43) Pub. Date: Dec. 23, 2004

(54) Configuring an electronic course

(76) Inventors: Marcus Philipp, Diepheim (DE); Michael Altenhofen, Karlsruhe (DE); Andreas S. Krebs, Karlsruhe (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/464,051

(22) Filed: Jun. 17, 2003

(51) Int. Cl. G09B 19/00; G09B 3/00

(52) U.S. Cl. 434/350

(57) ABSTRACT

Configuring an electronic course includes receiving input associated with the electronic course, comparing data that corresponds to the input with pre-stored learning objectives of the electronic course, and providing a graphical presentation that includes elements from the electronic course. The graphical presentation includes a target element from the electronic course if the target element is associated with data that does not match at least one of the pre-stored learning objectives. The graphical presentation excludes the target element from the electronic course if the target element is associated with data that matches at least one of the pre-stored learning objectives.

### TECHNICAL FIELD

The application relates generally to configuring an electronic course and, more particularly, to selecting material to present during the electronic course.

### BACKGROUND

Systems and applications for delivering computer-based training (CBT) have existed for many years. However, CBT systems historically have not gained wide acceptance. A problem hindering the reception of CBTs as a means of training workers and users is the compatibility between systems. A CBT system works as a stand-alone system that is unable to use content designed for use with other CBT systems.

Early CBTs also were based on hypermedia systems that statically linked content. User guidance was given by annotating the hyperlinks with descriptive information. The trainee could proceed through learning material by traversing the links embedded in the material. The structure associated with the material was very rigid, and the material could not be easily written, edited, configured or reused to create additional or new learning material.

Newer methods for intelligent tutoring and CBT systems are based on special domain models that must be defined prior to creation of the course or content. Once a course is created, the material may not be easily adapted or changed for different users'specific training needs. Thus, such courses often fail to meet the needs of the trainee.

### SUMMARY

In general, in one aspect, the invention is directed to a method of configuring an electronic course. The method includes retrieving data from an element of the electronic course, comparing the data to learning objectives stored in a database, and configuring the electronic course based on comparison of the data to the learning objectives.

By way of example, the foregoing method may configure the electronic course by excluding course material that corresponds to a stored learning objectives. By excluding such course material, the method reduces the chances that a learner will view the same material twice, thereby increasing the efficiency of the electronic course.

The foregoing aspect of the invention may include one or more of the following features. Configuring the electronic course may include determining whether to present the element based on comparison of the data to the learning objectives. Configuring the electronic course may also include presenting the element during the electronic course if the data does not correspond to at least one of the stored learning objectives, and skipping the element during the electronic course if the data corresponds to at least one of the stored learning objectives. Skipping the element may mean excluding the element from presentation during the electronic course. The data may be metadata embedded in the element.

In general, in another aspect, the invention is directed to a method of configuring an electronic course. The method includes receiving input from a user of the electronic course, determining if a learning objective of the electronic course has been met in response to the input, and configuring the electronic course based on whether the learning objective has been met. This aspect of the invention may also include one or more of the following features.

A test may be presented to the user and the input may correspond to answers to a question in the test. Options relating to the electronic course may be presented to the user and the input may correspond to selection of one of the options. An element from the electronic course may be presented to the user and the input may correspond to a navigational input through the electronic course.

Determining if a learning objective of the electronic course has been met may include obtaining data based on the input and comparing the data to at least one learning objective stored in a database. Configuring the electronic course may include presenting course material for a first learning objective that does not correspond to the data and skipping course material for a second learning objective that does correspond to the data.

In general, in another aspect, the invention is directed to a method of configuring an electronic course, which includes receiving input associated with the electronic course, comparing data that corresponds to the input with pre-stored learning objectives of the electronic course, and providing a graphical presentation that includes elements from the electronic course. The graphical presentation includes a target element from the electronic course if the target element is associated with data that does not match at least one of the pre-stored learning objectives. The graphical presentation excludes the target element from the electronic course if the target element is associated with data that matches at least one of the pre-stored learning objectives.

The foregoing aspect may include one or more of the following features. The input may be received during presentation of the electronic course and/or prior to presentation of substantive material from the electronic course. Receiving the input may include presenting a test to a user (i.e., a learner), the test including questions associated with the pre-stored learning objectives, receiving answers to the test, and analyzing the answers to obtain the input. Receiving the input may include presenting options that permit selection of elements from the electronic course, receiving data that corresponds to a selected option, and generating the input from the data.

Other features and advantages will be apparent from the description, the drawings, and the claims.

### DESCRIPTION OF THE DRAWINGS

FIG. 1 is an exemplary content aggregation model.

FIG. 2 is an example of an ontology of knowledge types.

FIG. 3 is an example of a course graph for electronic learning.

FIG. 4 is an example of a sub-course graph for electronic learning.

FIG. 5 is an example of a learning unit graph for electronic learning.

FIG. 6 is a block diagram of an electronic learning system.

FIG. 7 is a flowchart showing a process for configuring an electronic course using a pretest.

FIG. 8 is a flowchart showing a process for configuring an electronic course based on user selections.

FIG. 9 is a flowchart showing a process for configuring an electronic course during navigation through the course.

Like reference numerals in different figures indicate like elements.

### DETAILED DESCRIPTION

Course Content And Structure

The electronic learning system and methodology described herein structures course material (i.e., content) so that the content is reusable and flexible. For example, the content structure allows the creator of a course to reuse existing content to create new or additional courses. In addition, the content structure provides flexible content delivery that may be adapted to the learning styles of different users.

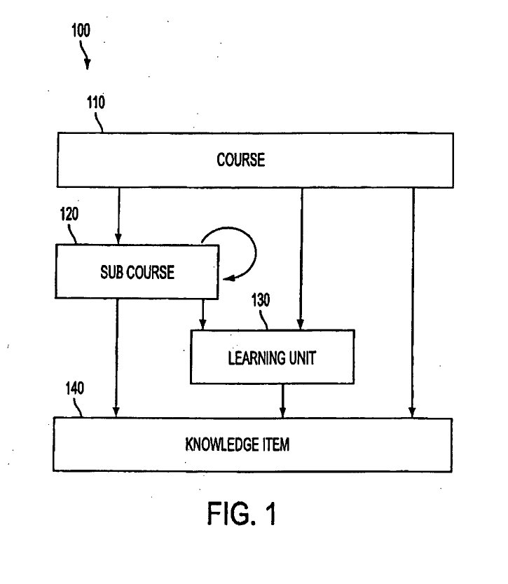

Electronic learning content may be aggregated using a number of structural elements arranged at different aggregation levels. Each higher-level structural element may refer to any instances of all structural elements of a lower level. At its lowest level, a structural element refers to content and is not further divided. According to one implementation shown in FIG. 1, course material 100 may be divided into four structural elements: a course 110, a sub-course 120, a learning unit 130, and a knowledge item 140.

Starting from the lowest level, knowledge items 140 are the basis for the other structural elements and are the building blocks of the course content structure. Each knowledge item 140 may include content that illustrates, explains, practices, or tests an aspect of a thematic area or topic. Knowledge items 140 typically are small in size (i.e., of short duration, e.g., approximately five minutes or less).

A number of attributes may be used to describe a knowledge item 140, such as, for example, a name, a type of media, and a type of knowledge. The name may be used by a learning system to identify and locate the content associated with a knowledge item 140. The type of media describes the form of the content that is associated with the knowledge item 140. For example, media types include a presentation type, a communication type, and an interactive type. A presentation media type may include a text, a table, an illustration, a graphic, an image, an animation, an audio clip, and/or a video clip. A communication media type may include a chat session, a group (e.g., a newsgroup, a team, a class, and a group of peers), an email, a short message service (SMS), and an instant message. An interactive media type may include a computer based training, a simulation, and a test.

A knowledge item 140 also may be described by the attribute of knowledge type. For example, knowledge types include knowledge of orientation, knowledge of action, knowledge of explanation, and knowledge of source/reference. Knowledge types may differ in learning goal and content. For example, knowledge of orientation offers a point of reference to the user, and, therefore, provides general information for a better understanding of the structure of interrelated structural elements. Each of the knowledge types is described in further detail below.

Knowledge items 140 may be generated using a wide range of technologies. In one embodiment, a browser (including plug-in applications) interprets and displays the appropriate file formats associated with each knowledge item. For example, markup languages (such as a Hypertext Markup language (HTML), a standard generalized markup language (SGML), a dynamic HTML (DHTML), or an extensible markup language (XML)), JavaScript (a client-side scripting language), and/or Flash may be used to create knowledge items 140.

HTML may be used to describe the logical elements and presentation of a document, such as, for example, text, headings, paragraphs, lists, tables, or image references.

Flash may be used as a file format for Flash movies and as a plug-in for playing Flash files in a browser. For example, Flash movies using vector and bitmap graphics, animations, transparencies, transitions, MP3 audio files, input forms, and interactions may be used. In addition, Flash allows a pixel-precise positioning of graphical elements to generate impressive and interactive applications for presentation of course material to a user.

Learning units 130 may be assembled using one or more knowledge items 140 to represent, for example, a distinct, thematically-coherent unit. Consequently, learning units 130 may be considered containers for knowledge items 140 of the same topic. Learning units 130 also may be considered relatively small in size (i.e., duration) though larger than a knowledge item 140.

Sub-courses 120 may be assembled using other sub-courses 120, learning units 130, and/or knowledge items 140. The sub-course 120 may be used to split up an extensive course into several smaller subordinate courses. Sub-courses 120 may be used to build an arbitrarily deep nested structure by referring to other sub-courses 120.

Courses may be assembled from all of the subordinate structural elements including sub-courses 120, learning units 130, and knowledge items 140. To foster maximum reuse, all structural elements may be self-contained and context free.

Structural elements also may be tagged with metadata that is used to support adaptive delivery, reusability, and search/retrieval of content associated with the structural elements. For example, learning objective metadata (LOM) defined by the IEEE “Learning Object Metadata Working Group” may be attached to individual course structure elements.

A learning objective corresponds to information that is to be imparted by an electronic course, or a structural element thereof, to a user taking the electronic course. The learning objective metadata noted above may represent numerical identifiers that correspond to learning objectives. The metadata may be used to configure an electronic course based on whether a user has met learning objectives associated with structural element(s) that make up the course.

Other metadata may relate to a number of knowledge types (e.g., orientation, action, explanation, and resources) that may be used to categorize structural elements.

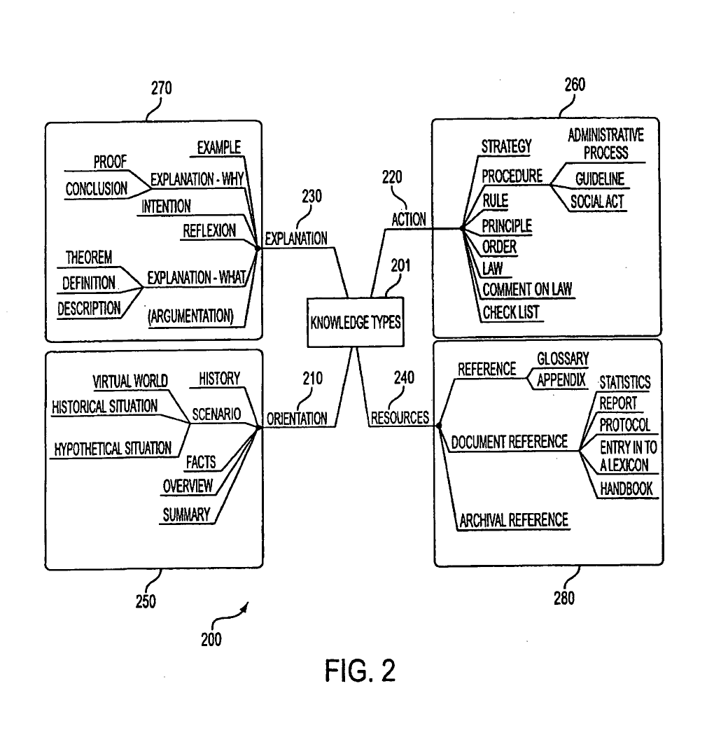

As shown in FIG. 2, structural elements may be categorized using a didactical ontology 200 of knowledge types 201 that includes orientation knowledge 210, action knowledge 220, explanation knowledge 230, and resource knowledge 240. Orientation knowledge 210 helps a user to find their way through a topic without acting in a topic-specific manner and may be referred to as “know what”. Action knowledge 220 helps a user to acquire topic related skills and may be referred to as “know how”. Explanation knowledge 230 provides a user with an explanation of why something is the way it is and may be referred to as “know why”. Resource knowledge 240 teaches a user where to find additional information on a specific topic and may be referred to as “know where”.

The four knowledge types (orientation, action, explanation, and resource) may be further divided into a fine grained ontology as shown in FIG. 2. For example, orientation knowledge 210 may refer to sub-types 250 that include a history, a scenario, a fact, an overview, and a summary. Action knowledge 220 may refer to sub-types 260 that include a strategy, a procedure, a rule, a principle, an order, a law, a comment on law, and a checklist. Explanation knowledge 230 may refer to sub-types 270 that include an example, an intention, a reflection, an explanation of why or what, and an argumentation. Resource knowledge 240 may refer to sub-types 280 that include a reference, a document reference, and an archival reference.

Dependencies between structural elements may be described by relations when assembling the structural elements at one aggregation level. A relation may be used to describe the natural, subject-taxonomic relation between the structural elements. A relation may be directional or non-directional. A directional relation may be used to indicate that the relation between structural elements is true only in one direction. Directional relations should be followed. Relations may be divided into two categories: subject-taxonomic and non-subject taxonomic.

Subject-taxonomic relations may be further divided into hierarchical relations and associative relations. Hierarchical relations may be used to express a relation between structural elements that have a relation of subordination or superordination. For example, a hierarchical relation between knowledge items A and B exists if B is part of A. Hierarchical relations may be divided into two categories: the part/whole relation (i.e., “has part”) and the abstraction relation (i.e., “generalizes”). For example, the part/whole relation “A has part B” describes that B is part of A. The abstraction relation “A generalizes B” implies that B is a specific type of A (e.g., an aircraft generalizes a jet or a jet is a specific type of aircraft).

Associative relations may be used to refer to a kind of relation of relevancy between two structural elements. Associative relations may help a user obtain a better understanding of facts associated with the structural elements. Associative relations describe a manifold relation between two structural elements and are mainly directional (i.e., the relation between structural elements is true only in one direction). Examples of associative relations, described below, include “determines,” “side-by-side,” “alternative to,” “opposite to,” “precedes,” “context of,” “process of,” “values,” “means of,” and “affinity.”

The “determines” relation describes a deterministic correlation between A and B (e.g., B causally depends on A). The “side-by-side” relation may be viewed from a spatial, conceptual, theoretical, or ontological perspective (e.g., A side-by-side with B is valid if both knowledge objects are part of a superordinate whole). The side-by-side relation may be subdivided into relations, such as “similar to,” “alternative to,” and “analogous to.” The “opposite to” relation implies that two structural elements are opposite in reference to at least one quality. The “precedes” relation describes a temporal relationship of succession (e.g., A occurs in time before B (and not that A is a prerequisite of B)). The “context of ” relation describes the factual and situational relationship on a basis of which one of the related structural elements may be derived. An “affinity” between structural elements suggests that there is a close functional correlation between the structural elements (e.g., there is an affinity between books and the act of reading because reading is the main function of books).

Non Subject-Taxonomic relations may include the relations “prerequisite of” and “belongs to.” The “prerequisite of” and the “belongs to” relations do not refer to the subject-taxonomic interrelations of the knowledge to be imparted. Instead, these relations refer to progression of the course in the learning environment (e.g., as the user traverses the course). The “prerequisite of” relation is directional whereas the “belongs to” relation is non-directional. Both relations may be used for knowledge items 140 that cannot be further subdivided. For example, if the size of a screen is too small to display the entire content on one page, the page displaying the content may be split into two pages that are connected by the relation “prerequisite of.”

Another type of metadata is competencies. Competencies may be assigned to structural elements, such as, for example, a sub-course 120 or a learning unit 130. The competencies may be used to indicate and evaluate the performance of a user as the user traverses the course material. A competency may be classified as a cognitive skill, an emotional skill, a sensory motor skill, or a social skill.

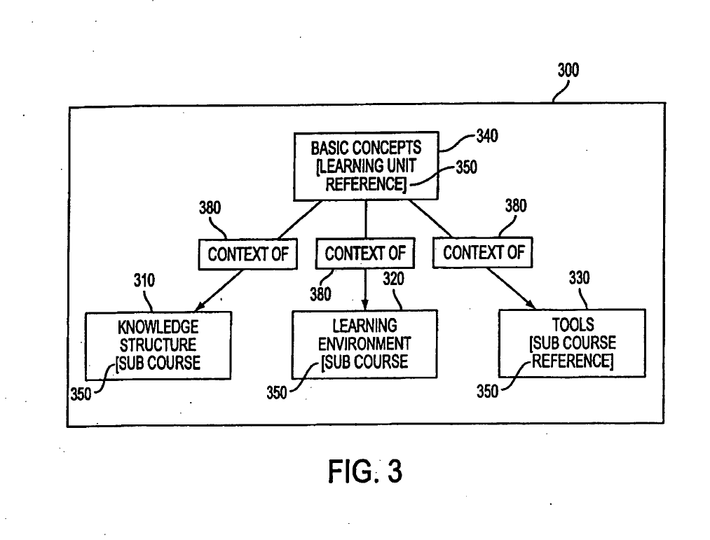

The content structure associated with a course may be represented as a set of graphs. A structural element may be represented as a node in a graph. Node attributes are used to convey the metadata attached to the corresponding structural element (e.g., a name, a knowledge type, a competency, and/or a media type). A relation between two structural elements may be represented as an edge. For example, FIG. 3 shows a graph 300 for a course. The course is divided into four structural elements or nodes (310, 320, 330, and 340): three sub-courses (e.g., knowledge structure, learning environment, and tools) and one learning unit (e.g., basic concepts).

A node attribute 350 of each node is shown in brackets (e.g., the node labeled “Basic concepts” has an attribute that identifies it as a reference to a learning unit). In addition, an edge 380 expressing the relation “context of” has been specified for the learning unit with respect to each of the sub-courses. As a result, the basic concepts explained in the learning unit provide the context for the concepts covered in the three sub-courses.

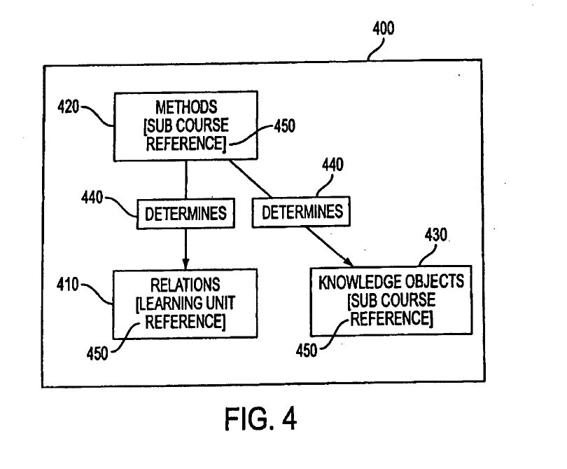

FIG. 4 shows a graph 400 of the sub-course “Knowledge structure” 310 of FIG. 3. In this example, the sub-course “Knowledge structure ” is further divided into three nodes (410, 420, and 430): a learning unit (e.g., on relations) and two sub-courses (e.g., covering the topics of methods and knowledge objects). The edge 440 expressing the relation “determines” is provided between the structural elements (e.g., the sub-course “Methods” determines the sub-course “Knowledge objects” and the learning unit “Relations”). In addition, the attribute 450 of each node is shown in brackets (e.g., nodes “Methods” and “Knowledge objects” have the attribute identifying them as references to other sub-courses; node “Relations” has the attribute of being a reference to a learning unit).

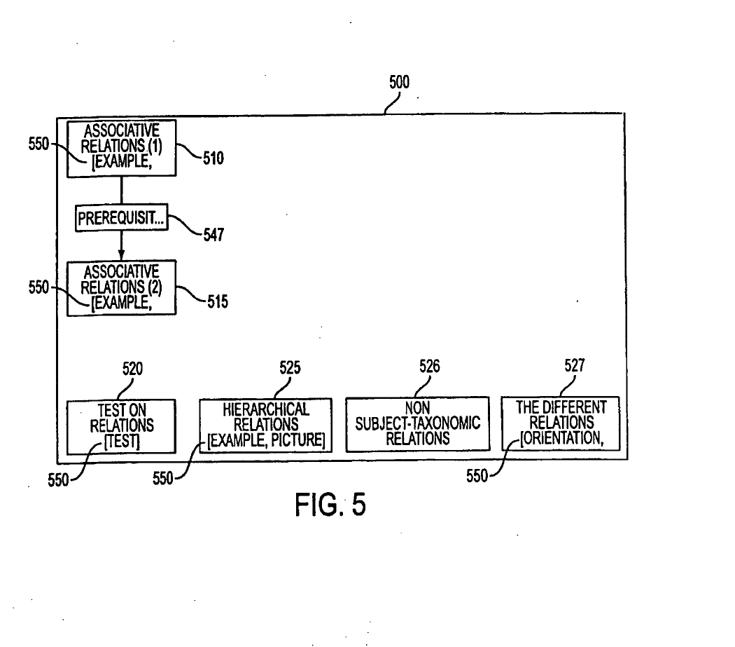

FIG. 5 shows a graph 500 for the learning unit “Relations” 410 shown in FIG. 4. The learning unit includes six nodes (510, 515, 520, 525, 526, 527): six knowledge items (i.e., “Associative relations (1)”, “Associative relations (2)”, “Test on relations”, “Hierarchical relations”, “Non subject-taxonomic relations”, and “The different relations”. An edge 547 expressing the relation “prerequisite” has been provided between the knowledge items “Associative relations (1)” and “Associative relations (2).” In addition, attributes 550 of each node are specified in brackets (e.g., the node “Hierarchical relations” includes the attributes “Example” and “Picture”.

Electronic learning Strategies

The above-described content aggregation and structure associated with a course does not automatically enforce any sequence that a user may use to traverse the content associated with the course. As a result, different sequencing rules may be applied to the same course structure to provide different paths through the course. The sequencing rules applied to the knowledge structure of a course are learning strategies. The learning strategies may be used to pick specific structural elements to be suggested to the user as the user progresses through the course. The user or supervisor (e.g., a tutor) may select from a number of different learning strategies while taking a course. In turn, the selected learning strategy considers both the requirements of the course structure and the preferences of the user.

In a traditional classroom, a teacher determines the learning strategy that is used to learn course material. For example, in this context the learning progression may start with a course orientation, followed by an explanation (with examples), an action, and practice. Using the electronic learning system and methods described herein, a user may choose between one or more learning strategies to determine which path to take through an electronic course. As a result, progressions of different users through the course may differ.

Learning strategies may be created using macro-strategies and micro-strategies. A user may select from a number of different learning strategies when taking a course. The learning strategies are selected at run time of the presentation of course content to the user (and not during the design of the knowledge structure of the course). As result, course authors are relieved from the burden of determining a sequence or an order of presentation of the course material. Instead, course authors may focus on structuring and annotating the course material. In addition, authors are not required to apply complex rules or Boolean expressions to domain models thus minimizing the training necessary to use the system. Furthermore, the course material may be easily adapted and reused to edit and create new courses.

Macro-strategies are used in learning strategies to refer to the coarse-grained structure of a course (i.e., the organization of sub-courses 120 and learning units 130). The macro-strategy determines the sequence that sub-courses 120 and learning units 130 are presented to the user. Basic macro-strategies include “inductive” and “deductive,” which allow the user to work through the course from the general to the specific or the specific to the general, respectively. Other examples of macro-strategies include “goal-based, top-down, ” “goal-based, bottom-up,” and “table of contents.”

Goal-based, top-down follows a deductive approach. The structural hierarchies are traversed from top to bottom. Relations within one structural element are ignored if the relation does not specify a hierarchical dependency. Goal-based bottom-up follows an inductive approach by doing a depth first traversal of the course material. The table of contents simply ignores all relations.

Micro-strategies, implemented by the learning strategies, target the learning progression within a learning unit. The micro-strategies determine the order that knowledge items of a learning unit are presented. Micro-strategies refer to the attributes describing the knowledge items. Examples of micro-strategies include “orientation only”, “action oriented”, “explanation-oriented”and “table of contents”.

The micro-strategy “orientation only” ignores all knowledge items that are not classified as orientation knowledge. The “orientation only” strategy may be best suited to implement an overview of the course. The micro-strategy “action oriented” first picks knowledge items that are classified as action knowledge. All other knowledge items are sorted in their natural order (i.e., as they appear in the knowledge structure of the learning unit). The micro-strategy “explanation oriented” is similar to action oriented and focuses on explanation knowledge. Orientation oriented is similar to action oriented and focuses on orientation knowledge. The micro-strategy “table of contents” operates like the macro-strategy table of contents (but on a learning unit level).

In one implementation, no dependencies between macro-strategies and micro-strategies exist. Therefore, any combination of macro and micro-strategies may be used when taking a course.

Electronic learning System

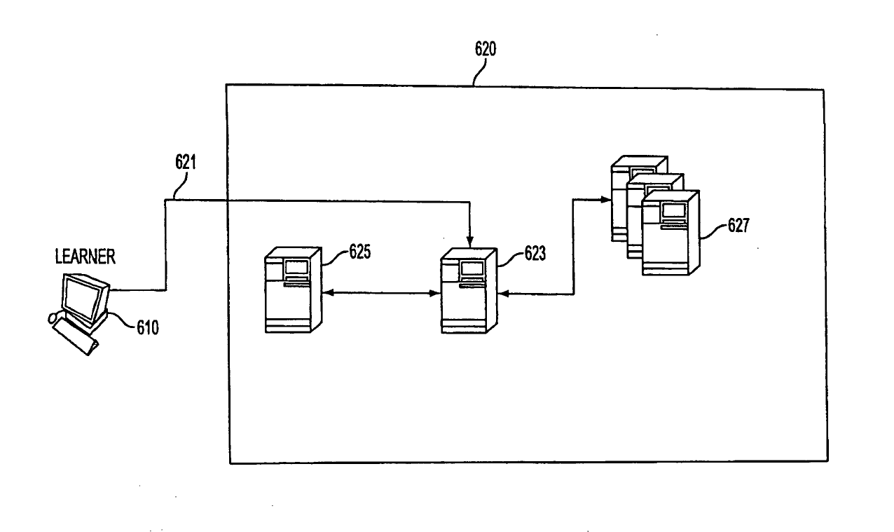

As shown in FIG. 6 an electronic learning architecture 600 may include a learning station 610 and a learning system 620. The user may access course material using a learning station 610 (e.g., a learning portal). The learning station 610 may be implemented using a work station, a computer, a portable computing device, or any intelligent device capable of executing instructions and connecting to a network. The learning station 610 may include any number of devices and/or peripherals (e.g., displays, memory/storage devices, input devices, interfaces, printers, communication cards, and speakers) that facilitate access to and use of course material.

The learning station 610 may execute any number of software applications, including an application that is configured to access, interpret, and present courses and related information to a user. The software may be implemented using a browser, such as, for example, Netscape communicator, Microsoft's Internet explorer, or any other software application that may be used to interpret and process a markup language, such as HTML, SGML, DHTML, or XML.

The browser also may include software plug-in applications that allow the browser to interpret, process, and present different types of information. The browser may include any number of application tools, such as, for example, Java, Active X, JavaScript, and Flash.

The browser may be used to implement a learning portal that allows a user to access the learning system 620. A link 621 between the learning portal and the learning system 620 may be configured to send and receive signals (e.g., electrical, electromagnetic, or optical). In addition, the link may be a wireless link that uses electromagnetic signals (e.g., radio, infrared, to microwave) to convey information between the learning station and the learning system.

The learning system may include one or more servers. As shown in FIG. 6, the learning system 620 includes a learning management system 623, a content management system 625, and an administration management system 627. Each of these systems may be implemented using one or more servers, processors, or intelligent network devices.

The administration system may be implemented using a server, such as, for example, the SAP R/3 4.6C+LSO Add-On. The administration system may include a database of user accounts and course information. For example, the user account may comprise a profile containing demographic data about the user (e.g., a name, an age, a sex, an address, a company, a school, an account number, and a bill) and his/her progress through the course material (e.g., places visited, tests completed, skills gained, knowledge acquired, and competency using the material). The administration system also may provide additional information about courses, such as the courses offered, the author/instructor of a course, and the most popular courses.

The content management system may include a learning content server. The learning content server may be implemented using a WebDAV server. The learning content server may include a content repository. The content repository may store course files and media files that are used to present a course to a user at the learning station. The course files may include the structural elements that make up a course and may be stored as XML files. The media files may be used to store the content that is included in the course and assembled for presentation to the user at the learning station.

The learning management system may include a content player. The content player may be implemented using a server, such as, an SAP J2EE Engine. The content player is used to obtain course material from the content repository. The content player also applies the learning strategies to the obtained course material to generate a navigation tree for the user. The navigation tree is used to suggest a route through the course material for the user and to generate a presentation of course material to the user based on the learning strategy selected by the user.

The learning management system also may include an interface for exchanging information with the administration system. For example, the content player may update the user account information as the user progresses through the course material.

Course Configuration

The structure of a course is made up of graphs of the structural elements. A navigation tree may be determined from the graphs by applying a selected learning strategy to the graphs. The navigation tree may be used to navigate a path through the course for the user. Only parts of the navigation tree may be displayed to the user at the learning portal based on the position of the user within the course.

As described above, learning strategies are applied to static course structure including structural elements (nodes), metadata (attributes), and relations (edges). This data is created when the course structure is determined (e.g., by a course author). Once the course structure is created, the course player processes the course structure using a strategy to present the material to the user at the learning portal. The course may be custom-tailored to a user's needs either before or during presentation of the materials.

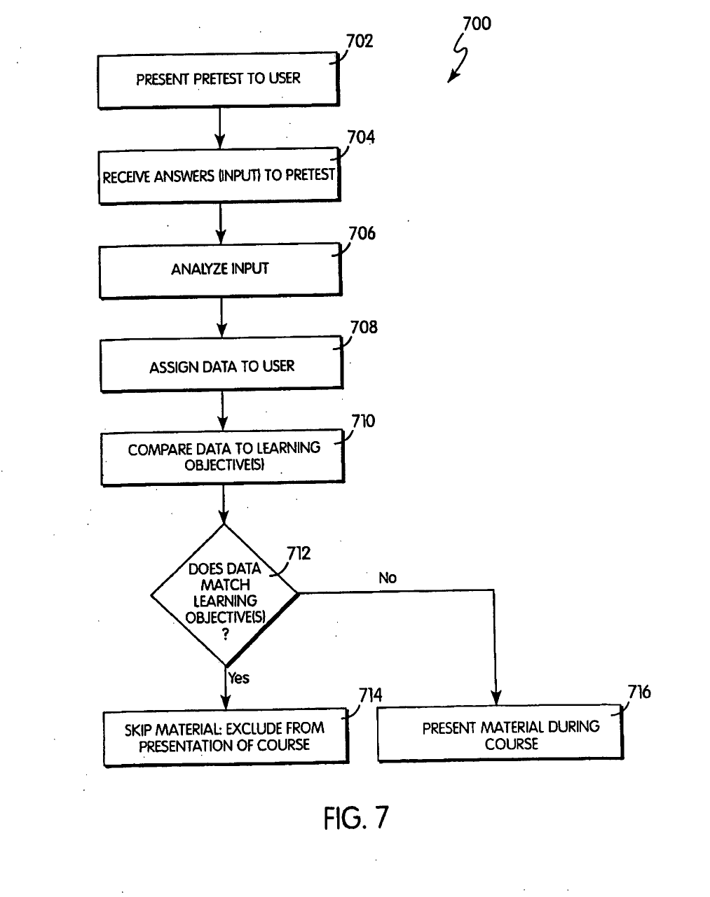

Described below are methods for configuring an electronic course in the electronic learning system of FIG. 6. In this context, “configuring” refers to selecting which course material (i.e., content) to display and which to skip (i.e., exclude) during presentation of a course. Shown in FIGS. 7 to 9 are several different methods of configuring a course. Each of these methods may be used alone or in combination with one or more of the other methods described herein.

FIG. 7 shows a method of configuring an electronic course that is based on use of a pretest. In this context, a pretest is an examination presented to a user prior to start of an electronic course or portion thereof. The examination may be any type of examination, such as multiple-choice, fill-in-the-blank, etc. The questions in the pretest relate to learning objectives associated with the electronic course.

The questions may relate to learning objectives of the electronic course as a whole or to learning objectives of individual structural elements of the course. There may be a one-to-one correspondence between test questions and learning objectives or multiple test questions may relate to a single learning objective. Conversely, a single question on a pretest may relate to multiple learning objectives.

The questions are designed to elicit a response, which is indicative of knowledge associated with specific learning objectives. For example, if the electronic course relates to basic computing, one or more questions on an associated pretest may be designed to elicit responses that indicate that the user is familiar with use of a computer mouse. In another example, if the electronic course relates to a foreign language, one or more questions on the pretest may be designed to elicit responses that indicate the user's level of skill in the foreign language.

In FIG. 7, process 700 presents (702) a pretest to a user. The pretest may be presented, e.g., on learning system 610 (FIG. 6). In this embodiment, the pretest is presented prior to beginning the electronic course. However, in other embodiments, the pretest may be presented during an electronic course, e.g., at the start of each new section (e.g., each new structural element) of the electronic course. The user provides responses (i.e., answers) to questions in the pretest, which are received (704) by process 700. The format of the answers depends on the format of the pretest. For example, if the pretest is a “true or false” test, then the answers may simply be “true” or “false”

Process 700 may analyze (706) the answers to determine if the user has met a learning objective associated with the pretest. Any type of analysis may be performed to correlate pretest question answers to a specific learning objective(s). If process 700 determines, based on the analysis, that the user has met a learning objective, process 700 assigns (708) data associated with the learning objective to the user. The data may be any sort of identifier(s), which indicate that the user has completed a learning objective associated with the pretest. In one embodiment, each learning objective is assigned a unique number. In this case, the data corresponds to a numerical identifier of the learning objective.

It was stated above that process 700 assigns “to the user” data indicating that the user has completed a learning objective. What this means is that the electronic learning system saves data associated with each user, e.g., in a user profile or the like stored in the user's account. Each time a user enters the electronic learning system (e.g., via a password protected Web page), the electronic learning system accesses data associated with the user and utilizes this data to custom-configure the electronic course for the user.

To this end, process 700 compares (710) the learning objective data for a user (which indicates learning objectives that the user has completed) to metadata associated with structural elements of the electronic course. As noted, the metadata identifies the learning objective(s) associated with a particular structural element of the electronic course. The metadata may be stored in a Web page for each structural element and/or with any other data that is accessed to present course material associated with the structural element.

In this embodiment, the pretest is presented to the user prior to beginning the electronic course. Accordingly, the comparison (710) is performed prior to presenting material for the electronic course. In other embodiments, the pretest may be given at any point during the electronic course. In such cases, the comparison (710) would occur during the course.

If learning objective data for the user matches (712) metadata in a structural element, process 700 skips (714) the structural element. What this means is that process 700 excludes course material associated with the structural element from presentation during the electronic course. This material is skipped because the match (712) indicates that the user has already achieved the learning objective associated with the structural element. As such, there is no need for material associated with the structural element to be presented to the user during the course.

If the learning objective data for the user does not match (712) the metadata in a structural element, process 700 includes (716) course material associated with the structural element in a presentation of the electronic course. The course material is presented because a failed “match” indicates that the user has not yet achieved the learning objective associated with the structural element and, therefore, needs to review the relevant course material.

Inclusion or exclusion of material from presentation during the electronic course may be performed by storing some indication (e.g., pointers) of information to be presented during the electronic course. The appropriate information may then be retrieved for presentation during the course.

The foregoing describes skipping structural elements of a course based on their metadata. However, as described above, the definition of a “structural element” is relative in that an entire course may act as a structural element of a larger course. Accordingly, metadata for an entire course may be compared to user learning objective data, and the entire course skipped if there is a match.

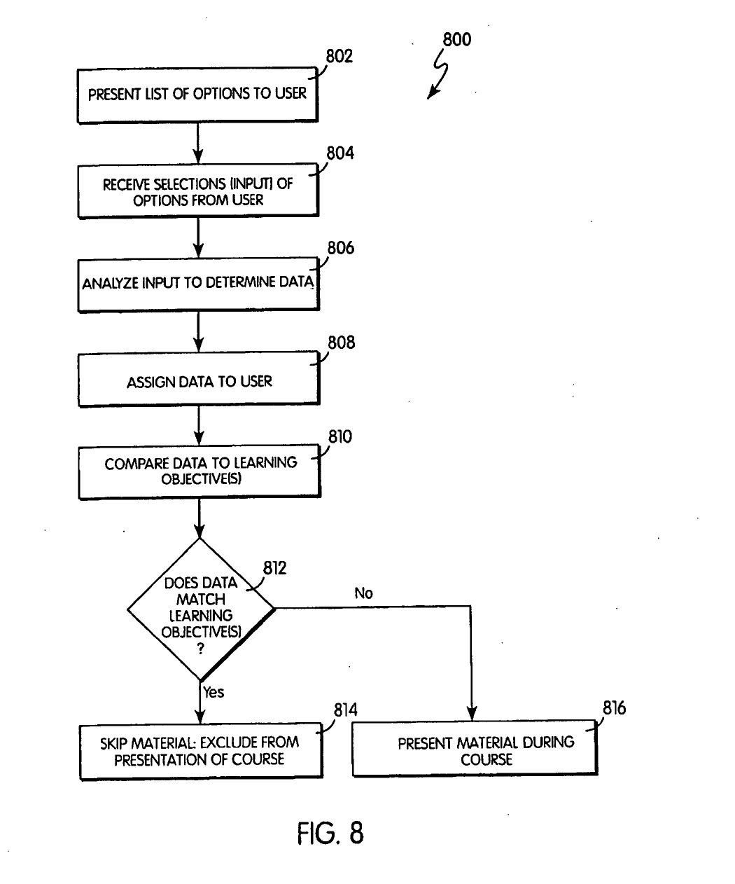

FIG. 8 shows an another process 800 that may be used to configure an electronic course. In process 800, the user is presented with a list of course materials (e.g., a table of contents) and can select which materials to view during the course. This is in contrast to process 700, which presents the user with a pretest and then determines, based on answers to the pretest, which course materials to present.

Referring to FIG. 8, process 800 presents (802) a list of options to a user. The list may be descriptive of materials that can be viewed during the electronic course. As mentioned above, a table of contents or the like may be presented.

In this embodiment, the list is presented prior to beginning an electronic course. However, in other embodiments, the list may be presented during an electronic course, e.g., at the start of each new section (e.g., each new structural element) of the electronic course. The user selects one or more options from the list and process 800 receives (804) the user's selection(s).

Each selection on the list may be associated with learning objective data stored in memory. Process 800 analyzes (806) the received selections to obtain learning objective data associated with the selections. This learning objective data may be retrieved from memory (e.g., a database) by process 800 and assigned (808) to the user.

Process 800 compares (812) the learning objective data associated with the user's selections to metadata associated with structural elements of the electronic course. As noted above, the metadata may be stored in a Web page associated with each structural element and/or with any other data that is accessed to present course material.

If the learning objective data associated with a selection matches (812) the metadata in a structural element, process 800 skips (814) the structural element. That is, process 800 excludes course material associated with the structural element from presentation during the electronic course. This material is skipped because the match (812) indicates that the user has not achieved (by selection) the learning objective(s) associated with the structural element. As such, the material associated with the structural element will not be presented to the user during the electronic course.

If the learning objective data associated with a selection does not match (812) the metadata in a structural element, process 800 includes (816) course material associated with the structural element in the presentation of the electronic course. The course material is presented because a failed match indicates that the user does not have the learning objective(s) associated with the structural element.

As above, inclusion or exclusion of material from presentation during the electronic course may be performed by storing some indication of information to be presented during the electronic course. The appropriate information may then be retrieved for presentation during the course.

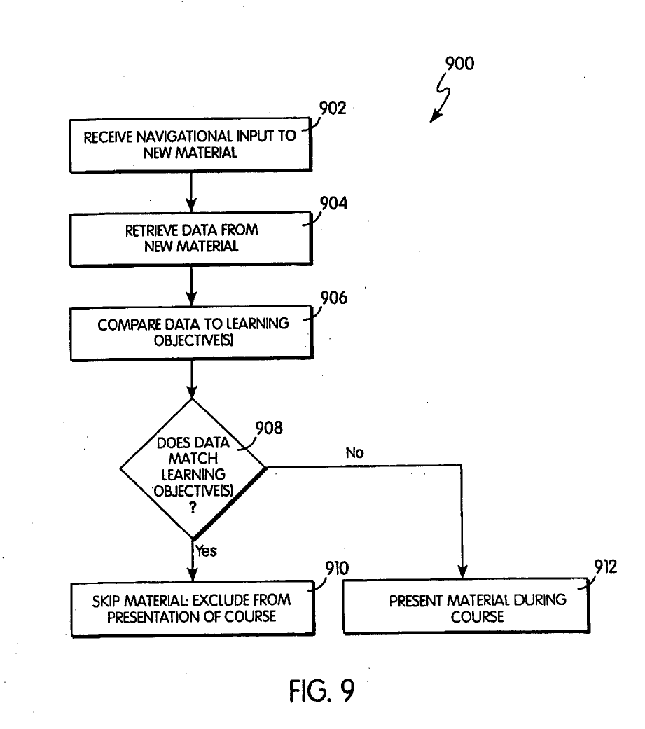

FIG. 9 shows another process 900 that may be used to configure an electronic course. Process 900 may be performed during navigation through the electronic course.

Referring to FIG. 9, process 900 receives (901) a navigational input to the electronic course. A navigational input may be any sort of input by which a user moves through the electronic course. One example of a navigational input is clicking on navigational arrows in the course. Another example is selecting a hyperlink in the course. There are also many other possible navigational inputs.

In response to the navigational input, process 900 retrieves (904) learning objective data for the user. The learning objective data may be obtained, e.g., via a pretest or via selection from a list of options, as described above. Alternatively, learning objective data may be stored each time a user completes a portion (e.g., a structural element) of the electronic course. For example, each time the user completes a portion of the electronic course, process 900 may retrieve the learning objective data for that portion of the electronic course and store that learning objective data in association with the user, e.g., in the user's profile or account.

Accordingly, each time process 900 receives a navigational input to new material of the course (e.g., from one structural element to another), process 900 retrieves metadata associated with the new portion of the course. As above, the metadata may be retrieved from Web pages associated with the new material or any a database containing such data.

Process 900 compares (906) learning objective data for the user to the metadata associated with the new material in the course. If the two match (908), this indicates that the user has achieved the learning objective associated with the metadata. Under these circumstances, process 900 skips (910) the material (e.g., structural element) associated with the metadata. That is, process 900 excludes the material during presentation of the course, instead displaying the next material in order of the course. Which material is displayed next is determined beforehand by the author of the course.

If the learning objective data matches the metadata associated with the next material, process 900 skips that material, and so on until process 900 reaches material for which the user does not have learning objective(s).

Referring back to block 908, if the user's learning objective data does not match the metadata associated with the new material in the course, this means that the user has not achieved the learning objective associated with the new material. Accordingly, process 900 presents (912) the new material to the user as part of the electronic course.

Other Embodiments

Processes 700, 800 and 900 are applicable to situations where a user is navigating through more than one course or through a network of courses (called a “learning net”. Assume, by way of example, that two courses A and B in a learning net have the same learning objective. A user navigating through course A obtains a learning objective associated with course A. That learning objective is stored in memory in the manner described above.

Upon navigating to course B (e.g., from course A), process 900 retrieves learning objective(s) associated with course B and compares those learning objective(s) to the stored learning objective(s) for the user (e.g., obtained by going through course A). If there are any learning objective(s) associated with course B that match the user's stored learning objectives, process 900 skips the corresponding material in course B.

Thus, process 900 (and, likewise, processes 700 and 800) permit tracking of learning objectives across course borders. Accordingly, once a user obtains learning objectives associated with course material, the user does not need to view that course material again regardless of whether that course material is part of the same, or a different, course.

Processes 700, 800 and 900 are not limited to use with the hardware and software of FIGS. 1 to 6; they may find applicability in any computing or processing environment and with any type of machine that is capable of running machine-readable instructions, such as a computer program. Processes 700, 800 and 900 may be implemented in hardware, software, or a combination of the two. Processes 700, 800 and 900 may be implemented in computer programs executing on programmable computers that each include a processor, a storage medium readable by the processor (including volatile and non-volatile memory and/or storage elements), at least one input device, and one or more output devices. Program code may be applied to data entered using an input device (e.g., a mouse or keyboard) to perform processes 700, 800 and 900.

Each such program may be implemented in a high level procedural or object-oriented programming language to communicate with a computer system. However, the programs can be implemented in assembly or machine language. The language may be a compiled or an interpreted language.

Each computer program may be stored on a storage medium or device (e.g., CD-ROM, hard disk, or magnetic diskette) that is readable by a general or special purpose programmable computer for configuring and operating the computer when the storage medium or device is read by the computer to perform processes 700, 800 and 900. Processes 700, 800 and 900 may also be implemented as a computer-readable storage medium, configured with a computer program, where, upon execution, instructions in the computer program cause the computer to operate in accordance with processes 700, 800 and 900.

The invention is not limited to the embodiments set forth herein. For example, the blocks in the flowcharts may be rearranged and/or one or more blocks of the flowcharts may be omitted. The processes shown in the flowcharts may be used with electronic learning systems other than the electronic learning system described herein.

Other embodiments are also within the scope of the following claims.

What is claimed is:

1. A method of configuring an electronic course, the method comprising:
retrieving data from an element of the electronic course;
comparing the data to learning objectives stored in a database; and
configuring the electronic course based on comparison of the data to the learning objectives.

2. The method of claim 1, wherein configuring comprises:
determining whether to present the element based on comparison of the data to the learning objectives.

3. The method of claim 2, wherein configuring further comprises:
presenting the element during the electronic course if the data does not correspond to at least one of the learning objectives; and
skipping the element during the electronic course if the data corresponds to at least one of the learning objectives.

4. The method of claim 1, wherein skipping the element comprises excluding the element from presentation during the electronic course.

5. The method of claim 1, wherein the data comprises metadata embedded in the element.

6. A method of configuring an electronic course, comprising:
receiving input from a user of the electronic course;
determining if a learning objective of the electronic course has been met in response to the input; and
configuring the electronic course based on whether the learning objective has been met.

7. The method of claim 6, further comprising:
presenting a test to the user, the input corresponding to answers to a question in the test.

8. The method of claim 6, further comprising:
presenting, to the user, options relating to the electronic course, the input corresponding to selection of one of the options.

9. The method of claim 6, further comprising:
presenting, to the user, an element from the electronic course, the input corresponding to a navigational input through the electronic course.

10. The method of claim 6, wherein:
determining comprises:
obtaining data based on the input; and
comparing the data to at least one learning objective stored in a database; and
configuring comprises:
presenting course material for a first learning objective that does not correspond to the data; and
skipping course material for a second learning objective that does correspond to the data.

11. A method of configuring an electronic course, the method comprising:
receiving input associated with the electronic course;
comparing data that corresponds to the input with pre-stored learning objectives of the electronic course; and
providing a graphical presentation that includes elements from the electronic course, the graphical presentation including a target element from the electronic course if the target element is associated with data that does not match at least one of the pre-stored learning objectives, and the graphical presentation excluding the target element from the electronic course if the target element is associated with data that matches at least one of the pre-stored learning objectives.

12. The method of claim 11, wherein the input is received during presentation of the electronic course.

13. The method of claim 11, wherein the input is received prior to presentation of substantive material from the electronic course.

14. The method of claim 13, wherein receiving comprises:
presenting a test, the test including questions associated with the pre-stored learning objectives;
receiving answers to the test; and
analyzing the answers to obtain the input.

15. The method of claim 11, wherein receiving comprises:
presenting options that permit selection of elements from the electronic course;
receiving data that corresponds to a selected option; and
generating the input from the data.

16. A machine-readable medium that stores executable instructions for configuring an electronic course, the instructions causing a machine to:
retrieve data from an element of the electronic course;
compare the data to learning objectives stored in a database; and
configure the electronic course based on comparison of the data to the learning objectives.

17. The machine-readable medium of claim 16, wherein configuring comprises:
determining whether to present the element based on comparison of the data to the learning objectives.

18. The machine-readable medium of claim 17, wherein configuring further comprises:
presenting the element during the electronic course if the data does not correspond to at least one of the learning objectives; and
skipping the element during the electronic course if the data corresponds to at least one of the learning objectives.

19. The machine-readable medium of claim 16, wherein skipping the element comprises excluding the element from presentation during the electronic course.

20. The machine-readable medium of claim 16, wherein the data comprises metadata embedded in the element.

21. A machine-readable medium that stores executable instructions for configuring an electronic course, the instructions causing a machine to:
receive input from a user of the electronic course;
determine if a learning objective of the electronic course has been met in response to the input; and
configure the electronic course based on whether the learning objective has been met.

22. The machine-readable medium of claim 21, further comprising instructions that cause the machine to:
present a test to the user, the input corresponding to answers to a question in the test.

23. The machine-readable medium of claim 22, further comprising instructions that cause the machine to:
present, to the user, options relating to the electronic course, the input corresponding to selection of one of the options.

24. The machine-readable medium of claim 21, further comprising instructions that cause the machine to:
present, to the user, an element from the electronic course, the input corresponding to a navigational input through the electronic course.

25. The machine-readable medium of claim 21, wherein:
determining comprises:
obtaining data based on the input; and
comparing the data to at least one learning objective stored in a database; and
configuring comprises:
presenting course material for a first learning objective that does not correspond to the data; and
skipping course material for a second learning objective that does correspond to the data.

26. A machine-readable medium that stores executable instructions for configuring an electronic course, the instructions causing a machine to:
receive input associated with the electronic course;
compare data that corresponds to the input with pre-stored learning objectives of the electronic course; and
provide a graphical presentation that includes elements from the electronic course, the graphical presentation including a target element from the electronic course if the target element is associated with data that does not match at least one of the pre-stored learning objectives, and the graphical presentation excluding the target element from the electronic course if the target element is associated with data that matches at least one of the pre-stored learning objectives.

27. The machine-readable medium of claim 26, wherein the input is received during presentation of the electronic course.

28. The machine-readable medium of claim 26, wherein the input is received prior to presentation of substantive material from the electronic course.

29. The machine-readable medium of claim 28, wherein receiving comprises:
presenting a test, the test including questions associated with the pre-stored learning objectives;
receiving answers to the test; and
analyzing the answers to obtain the input.

30. The machine-readable medium of claim 26, wherein receiving comprises:
presenting options that permit selection of elements from the electronic course;
receiving data that corresponds to a selected option; and
generating the input from the data.

31. A system comprising at least one server for configuring an electronic course, the at least one server comprising at least one processor to:
retrieve data from an element of the electronic course;
compare the data to learning objectives stored in a database; and
configure the electronic course based on comparison of the data to the learning objectives.

32. The system of claim 31, wherein configuring comprises:
determining whether to present the element based on comparison of the data to the learning objectives.

33. The system of claim 32, wherein configuring further comprises:
presenting the element during the electronic course if the data does not correspond to at least one of the learning objectives; and
skipping the element during the electronic course if the data corresponds to at least one of the learning objectives.

34. The system of claim 31, wherein skipping the element comprises excluding the element from presentation during the electronic course.

35. The system of claim 31, wherein the data comprises metadata embedded in the element.

36. A system comprising at least one server for configuring an electronic course, the at least one server comprising at least one processor to:
receive input from a user of the electronic course;
determine if a learning objective of the electronic course has been met in response to the input; and
configure the electronic course based on whether the learning objective has been met.

37. The system of claim 36, wherein the at least one processor presents a test to the user, the input corresponding to answers to a question in the test.

38. The system of claim 36, wherein the at least one processor presents, to the user, options relating to the electronic course, the input corresponding to selection of one of the options.

39. The system of claim 36, wherein the at least one processor presents, to the user, an element from the electronic course, the input corresponding to a navigational input through the electronic course.

40. The system of claim 36, wherein:
determining comprises:
obtaining data based on the input; and
comparing the data to at least one learning objective stored in a database; and configuring comprises:
presenting course material for a first learning objective that does not correspond to the data; and
skipping course material for a second learning objective that does correspond to the data.

41. A system comprising at least one server for configuring an electronic course, the at least one server comprising at least one processor to:
receive input associated with the electronic course;
compare data that corresponds to the input with pre-stored learning objectives of the electronic course; and
provide a graphical presentation that includes elements from the electronic course, the graphical presentation including a target element from the electronic course if the target element is associated with data that does not match at least one of the pre-stored learning objectives, and the graphical presentation excluding the target element from the electronic course if the target element is associated with data that matches at least one of the pre-stored learning objectives.

42. The system of claim 41, wherein the input is received during presentation of the electronic course.

43. The system of claim 41, wherein the input is received prior to presentation of substantive material from the electronic course.

44. The system of claim 43, wherein receiving comprises:
presenting a test, the test including questions associated with the pre-stored learning objectives;
receiving answers to the test; and
analyzing the answers to obtain the input.

45. The system of claim 41, wherein receiving comprises:
presenting options that permit selection of elements from the electronic course;
receiving data that corresponds to a selected option; and
generating the input from the data.
